(19) United States
(12) Patent Application Publication
(10) Pub. No.: US 2012/0319947 A1
(43) Pub. Date: Dec. 20, 2012

(54) TRACK INPUT DEVICE AND SCROLLING CONTROL METHOD THEREOF

(76) Inventor: Chih-Heng NIEN, New Taipei (TW)

(21) Appl. No.: 13/517,699

(22) Filed: Jun. 14, 2012

(30) Foreign Application Priority Data
Jun. 15, 2011 (TW) 100120910

(51) Int. Cl. G06F 3/033

(52) U.S. Cl. 345/157

(57) ABSTRACT

A scrolling control method for a track input device including a sensing area and a controller is disclosed. The scrolling control method includes configuring a scrolling triggering area and a cursor area in the sensing area, receiving a first track signal at the sensing area, determining whether a displacement quantity of the first track signal is greater than a triggering threshold value when the first track signal is received by the scrolling triggering area, and entering a scrolling mode and sending a scrolling signal when the displacement quantity of the first track signal is greater than the triggering threshold value.

### CROSS-REFERENCE TO RELATED APPLICATIONS

This non-provisional application claims priority under 35 U.S.C. §119(a) on Patent Application No(s). 100120910 filed in Taiwan, R.O.C. on Jun. 15, 2011, the entire contents of which are hereby incorporated by reference.

### BACKGROUND

1. Technical Field

The disclosure relates to a track input device, and more particularly to a track input device.

2. Related Art

With technology development, electronic devices such as computer, mobile phone, automatic navigation system, and electronic game player are in a stronger requirement by consumers. Manufacturers strive to enhance functions of the electronic devices to attract more consumers. In order to make users operate an electronic device more conveniently, touch panels (which is also called as tablet or sensing panel) or other elements by which users can input operation tracks are developed for electronic devices. Various touch sensing approaches, for example, resistance touch panel, capacitance touch panel, coil touch panel, sound wave touch panel, infrared ray touch panel, and so on have been developed.

Compared with the conventional mouse, touch panel provides a user to input tracks to control the cursor. In this case, the user may experience intuition operation. However, the conventional touch panel does not have a scroll wheel as that of a mouse for scrolling a window page, and thus the conventional touch panel does not feature horizontal scrolling function or vertical scrolling function. In other words, the touch panel is not convenient as being an input device to browse a file or webpage having a size is larger than that of the panel.

Some manufacturers attempt to design a touch panel with scrolling function for example by setting additional button or switching track signals at the sensing area. However, these designs may cause additional hardware cost or an unanticipated switch due to error touch.

### SUMMARY

According to an embodiment, a scrolling control method for a track input device is disclosed. The scrolling control method comprises configuring a scrolling triggering area and a cursor area in a sensing area of the track input device, receiving a first track signal at the sensing area, determining whether a displacement quantity of the first track signal is greater than a triggering threshold value when the first track signal is received by the scrolling triggering area of the sensing area, and entering a scrolling mode and sending a scrolling signal when the displacement quantity of the first track signal is greater than the triggering threshold value.

According to another embodiment, a track input device is disclosed. The track input device comprises a sensing area for receiving a first track signal. The sensing area comprises a scrolling triggering area and a cursor area. The track input device further comprises a controller for determining whether a displacement quantity of the first track signal is greater than a triggering threshold value when the first track signal is received at the scrolling triggering area of the sensing area. Furthermore, when the displacement quantity is greater than the triggering threshold value, the track input device entering a scrolling mode and the controller sending a scrolling signal.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic view of a track input device according to an embodiment of the disclosure;

FIG. 2 is a flowchart of a method for scrolling control method according to an embodiment of the disclosure;

FIG. 3 illustrates an embodiment of a sensing area;

FIG. 4 illustrates an embodiment of a scrolling direction;

FIG. 5A illustrates an embodiment of a first component;

FIG. 5B illustrates another embodiment of a first component;

FIG. 6 illustrates an embodiment of a second component;

FIG. 7 illustrates an embodiment of a third component; and

FIG. 8 is a flowchart of a method for scrolling control method according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

The present disclosure provides a track input device and a scrolling control method. The scrolling control method is adaptable for the track input device and can be used to scroll a window page by using the track input device.

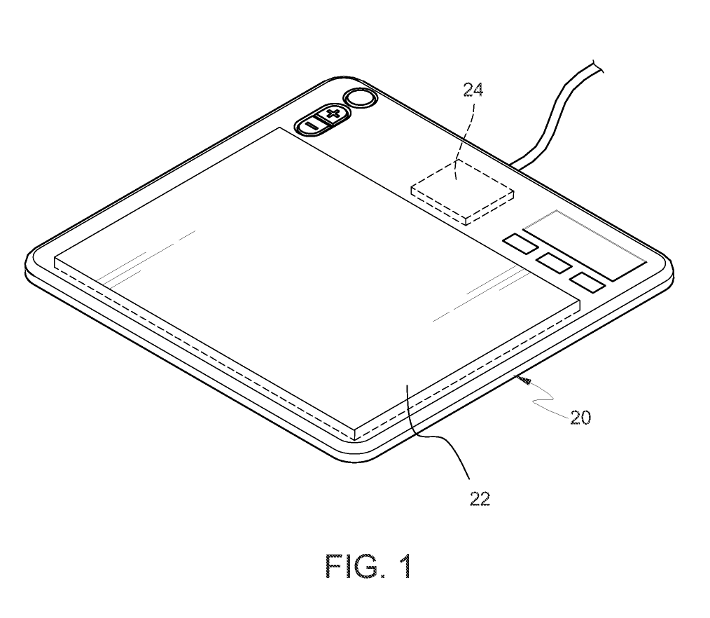

FIG. 1 is a schematic view of a track input device according to an embodiment of the disclosure. The track input device 20 includes a sensing panel having a sensing area 22 and a controller 24. The controller 24 is electrically connected to the sensing panel. The track input device 20 may be any devices by which users can input operation tracks. The track input device 20 for example is a digital board, handwriting board, drawing board, or game player with touch panel. The operation or data inputted by users through the track input device 20 is displayed on a display screen. Furthermore, the sensing panel may be for example a resistance, capacitance, coiling, sound wave, or infrared panel. The display screen may be a computer screen, mobile phone screen, or television screen, and etc.

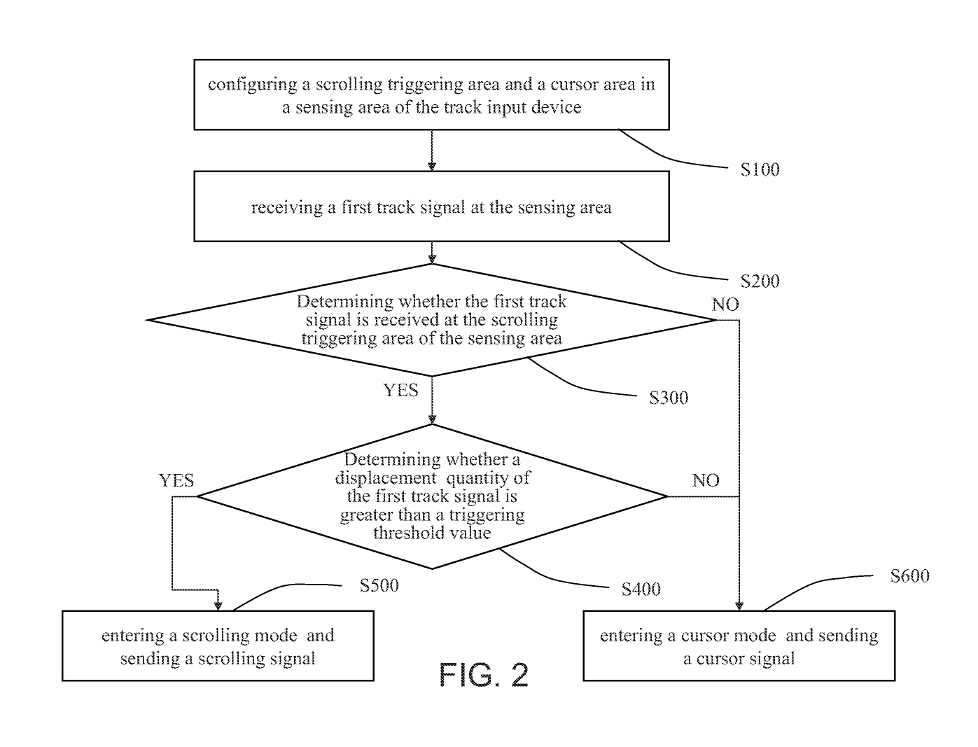

FIG. 2 is a flowchart of a scrolling control method according to an embodiment of the disclosure. With reference to FIG. 2, the scrolling control method performed on the track input device 20 is explained below.

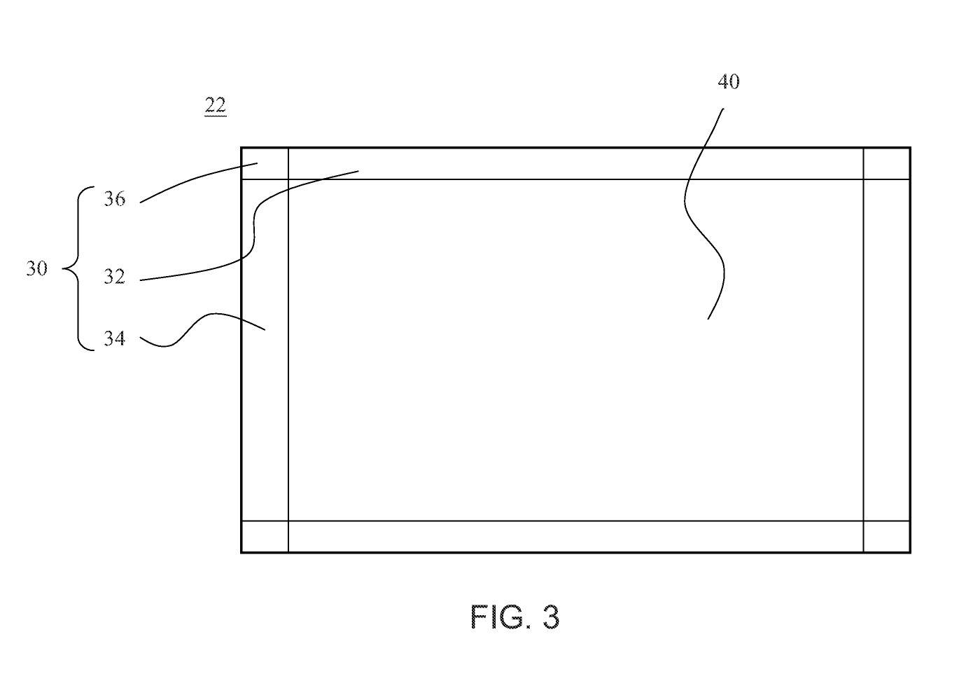

A scrolling triggering area and a cursor area are configured in the sensing area 22 of the track input device 20 (step S100). With reference to FIG. 3, FIG. 3 illustrates an embodiment of the sensing area.

According to the embodiment of FIG. 3, the periphery area of the sensing area 22 is configured to be the scrolling triggering area 30, and the central area of the sensing area 22 is configured to be the cursor area 40. The scrolling triggering area 30 can be configured to be at the right portion or bottom portion of the sensing area 22, or only at the right portion of the sensing area 22. The position of the scrolling triggering area 30 can be configured according to the application corresponding to the scrolling window page. In addition, the scrolling triggering area 30 and cursor area 40 can be reconfigured dynamically according to the application in use.

More particularly, the scrolling triggering area 30 may be divided into a plurality of sub-areas, and each sub-area corresponds to a scrolling direction. For example, the scrolling triggering area 30 may comprise two lateral sub-areas 32 with shape of rectangle at the upper and lower edges of the sensing area 22, two vertical sub-areas 34 with shape of rectangle at the left and right edges of the sensing area 22, and four double-axis sub-areas 36 with shape of rectangle at the four corners of the sensing area 22.

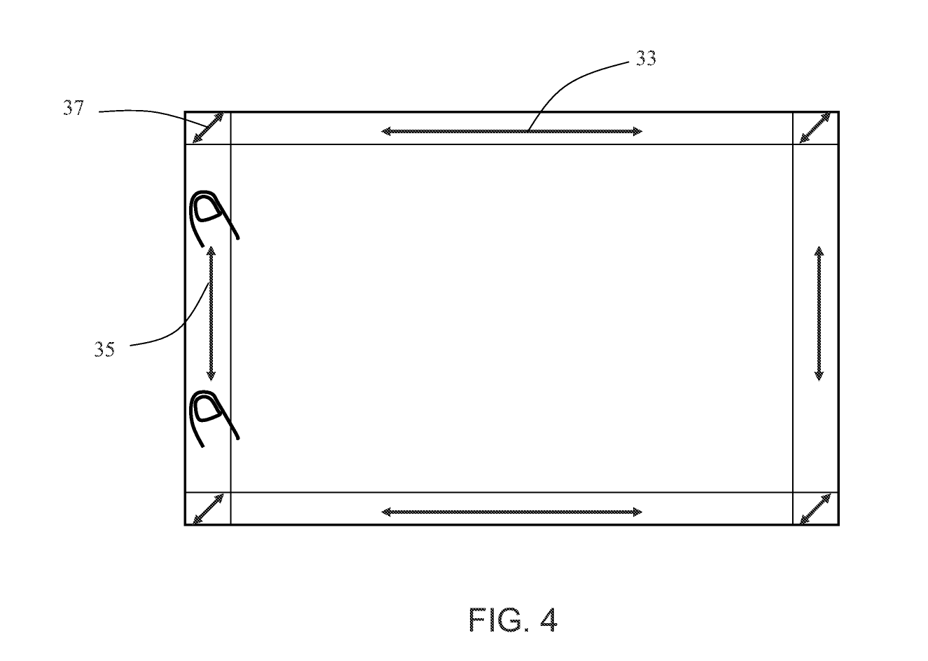

The sub-areas of the scrolling triggering area 30 correspond to different scrolling directions. As shown in FIG. 4, the lateral sub-areas 32 correspond to a horizontal direction 33, the vertical sub-areas 34 correspond to a vertical direction 35, and the double-axis sub-areas 36 correspond to a particular oblique direction 37. The oblique direction 37 for example forms an angle of 45° or 60° with the horizontal direction 33. Some sub-areas can be used to provide a single-axis scrolling function, i.e., scrolling the horizontal direction (R) or vertical direction (Z) of a window page. Also, some sub-areas may provide a double-axis scrolling function, i.e., scrolling both the horizontal direction and the vertical direction.

After the scrolling triggering area 30 is configured, the sensing area 22 receives a first track signal (step S200). The controller 24 determines whether the scrolling triggering area 30 receives the first track signal (step S300). If the scrolling triggering area 30 receives the first track signal, the controller 24 again determines whether the displacement quantity of the first track signal is greater than a triggering threshold value (step S400).

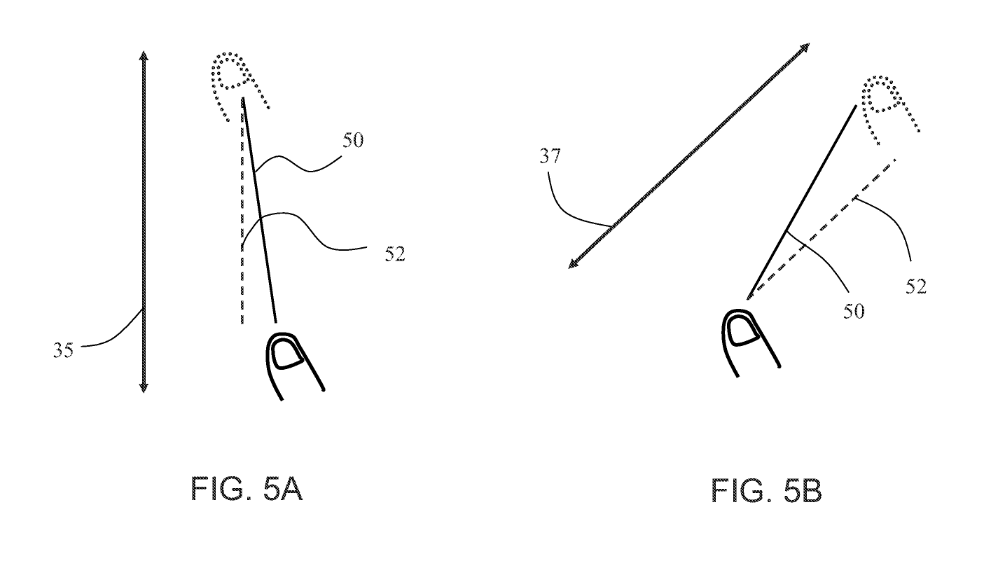

In the step 400, the controller 24 determines whether a first component of the displacement quantity which corresponds to a scrolling direction is greater than the triggering threshold value according to the sub-areas where the first track signal is received. The first component corresponding to the scrolling direction may record length but not direction. FIGS. 5A and 5B show two embodiments of the first component.

In the embodiment of FIG. 5, a user uses a finger to input the first track signal 50 in the vertical sub-area 34. The first track signal 50 may not move completely along the vertical direction 35. The controller 24 calculates the displacement quantity of the first track signal 50 according to the beginning point and the ending point of the first track signal 50, and then calculates the first component 52 along the vertical direction. Alternatively, the controller 24 may directly calculate the first component 52 according to the differential value between the vertical axis coordinate of the beginning point and the vertical axis coordinate of the ending point.

In the embodiment of FIG. 5B, a user uses a finger to input the first track signal 50 in the double-axis sub-area 36. The oblique direction 37 corresponding to the double-axis sub-area 36 forms an angle of 45° with the horizontal axis or the vertical axis. The controller 24 calculates the displacement quantity of the first track signal 50 according to the beginning point and the ending point of the first track signal 50, and then calculates the first component 52 along the oblique direction.

After the first component 52 is calculated, the controller again determines whether the first component 52 is greater than a triggering threshold value. Different triggering threshold values can be set for different scrolling directions of sub-areas. For example, the triggering threshold value for the horizontal sub-area 32 may be set as 30 pixels, and the triggering threshold value for the sub-area 36 may be set as 10 pixels since the double-axis sub-area 36 is smaller.

If the displacement quantity is greater than the triggering threshold value, the sensing panel enters a scrolling mode and sends a scrolling signal to provide the single-axis or double-axis scrolling function. Particularly, the sensing panel is at a preset cursor mode during idle time and provides a cursor control function. The sensing panel switches to the scrolling mode when the displacement quantity received by the scrolling triggering area 30 is greater than the triggering threshold value. As for different sub-areas, the scrolling mode can be further divided into a horizontal scrolling mode, a vertical scrolling mode, and a double-axis scrolling mode.

According to an embodiment, after the sensing panel enters a scrolling mode (step S500), the cursor area 40 receives a second track signal. The controller 24 sends a scrolling signal according to a second component of the second track signal which corresponds to the scrolling direction.

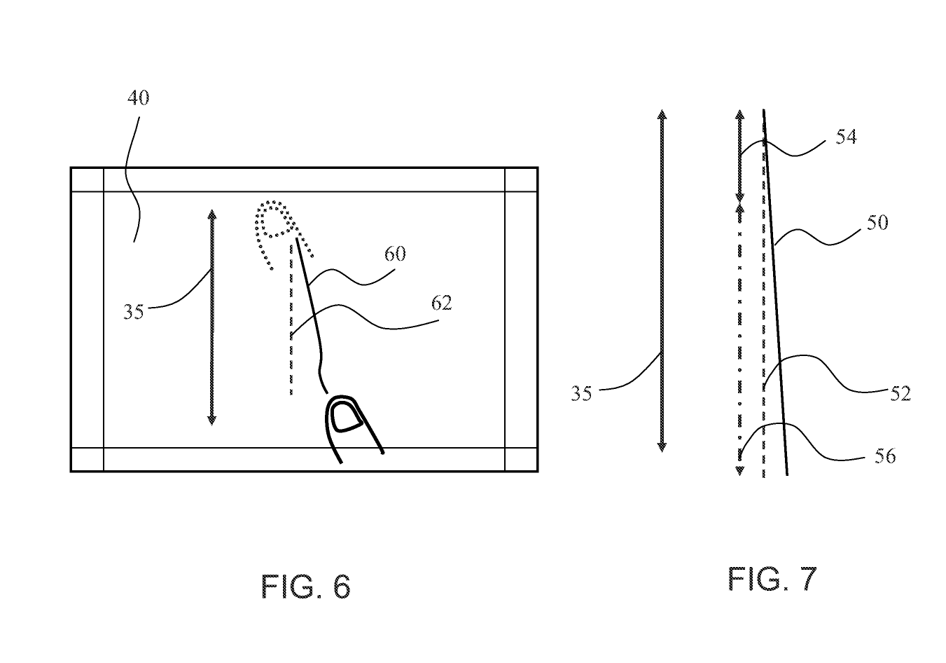

FIG. 6 illustrates an embodiment of the second component. Similar to the calculation method for the first component 52, the controller 24 calculates the displacement quantity of the second track signal 60 according to the beginning point and the ending point of the second track signal 60, and then calculates the second component 62 of the displacement quantity along the scrolling direction. The scrolling direction to be calculated corresponds to the scrolling mode. That is, if a user inputs a first track signal 50 in the vertical sub-area 34 and then the sensing panel enters the vertical scrolling mode, the scrolling direction of the second component 62 to be calculated is the vertical direction 35.

Then, the controller 24 sends a scrolling signal according to the amplitude of the second component 52. For example, if the amplitude of the second component 52 is larger, the scrolling amplitude of the window page is larger. In other words, if a user inputs the second track signal 60 by quickly sliding a finger across the screen, the window page is scrolled more quickly. Furthermore, in the embodiment of FIG. 6, a user slides a finger from up to down in the cursor area 40, and thus the scrolling signal orders the window page to scroll down.

According to another embodiment, after the sensing panel enters a scrolling mode (step S500), the controller 24 subtracts the first component 52 with the triggering threshold value and thus obtains the third component. A scrolling signal is sent according to the third component. The first component 52, the third component, and the triggering threshold value are all scalar quality instead of vector quality.

FIG. 7 illustrates an embodiment of the third component. After the first component 52 is calculated according to the above described steps, the third component 56 is obtained by subtracting the first component 52 with the triggering threshold value 54. For example, when the first component 52 is 125 pixels and the triggering threshold value 54 is 30 pixels, the third component is 95 pixels. The controller 24 then sends the scrolling signal according to parameters, such as the third component 56, the speed of inputting the first track signal 50 by sliding a finger across the screen, and so on.

In the other hand, if the first track signal 50 is received by the cursor area 40 of the sensing area 22 or if the displacement quantity of the first track signal 50 is smaller than or equal to the triggering threshold value 54, the sensing panel enters the cursor mode and sends a cursor signal (step S600). That is, if the scrolling mode is not triggered, the track input device 20 still maintains the cursor mode, and the controller 24 sends a cursor signal to provide the cursor control function according to the first track signal 50 inputted by a user.

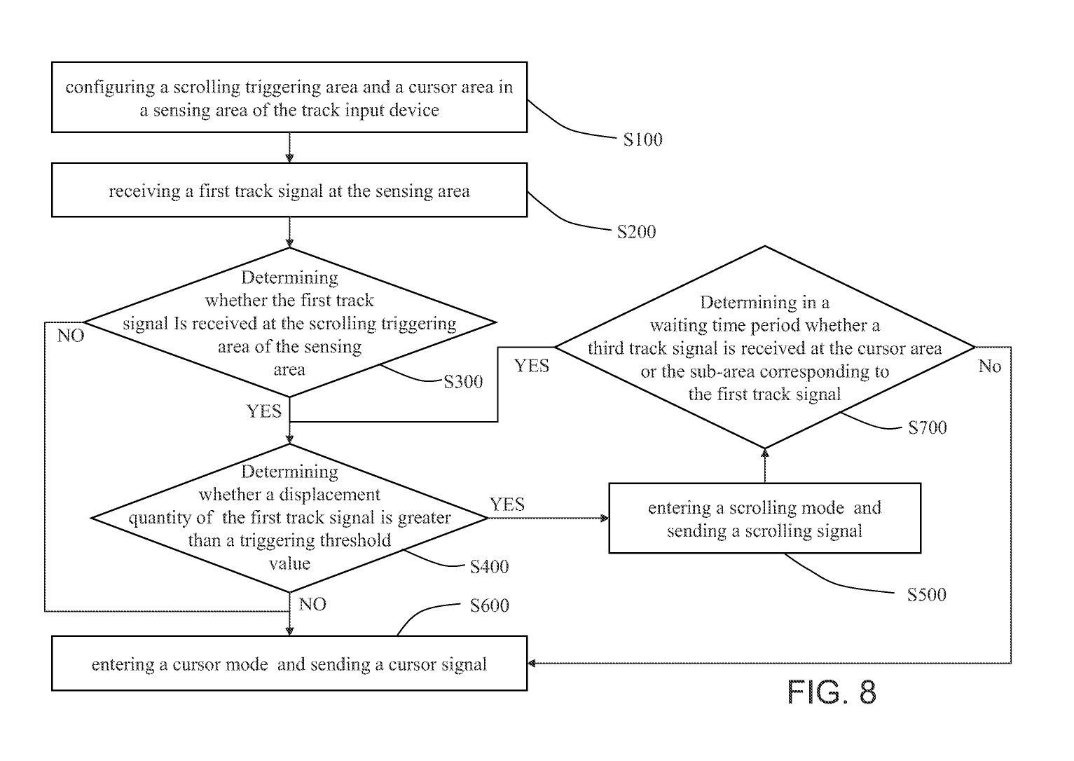

According to an embodiment, after the scrolling signal is sent, the track input device 20 may maintain the scrolling mode in a waiting time period. FIG. 8 is a flowchart of a scrolling control method according to another embodiment of the disclosure.

The track input device 20 maintains the scrolling mode in the waiting time period. The controller 24 determines whether the cursor area 40 or the sub-area corresponding to the first track signal 50 receives a third track signal during the waiting time period (step S700). In the waiting time period, the track input device 20 maintains the scrolling mode and sends the scrolling signal according to the third track signal. If the sensing area 22 does not receive any track signals during the waiting time period, the track input device enters the preset cursor mode from the scrolling mode.

Suppose that the waiting time period lasts one second and the first track signal 50 is inputted at the vertical sub-area 34. Within the one second after scrolling the window page by the second track signal 60 or the third component of the first track signal 50, a user may further input the second track signal 60 in the cursor area 40 or the vertical sub-area 34 to scroll the window page. On the other hand, if the track input device does not receive any track signal from a user in the one second, the track input device will switch to the cursor mode from the vertical scrolling mode.

In addition, in the waiting time period, the third track signal may be received in other sub-areas instead of the sub-area corresponding to the first track signal 50. In this case, the controller 24 determines whether the displacement quantity of the third track signal is greater than the triggering threshold value 54 to determine whether the track input device switches to another scrolling mode. For example, in the waiting time period for the vertical scrolling mode, if the displacement quantity of the third track signal received at the double-axis sub-area 36 is greater than the trigger threshold value 54 of the double-axis sub-area 36, the track input device switches to the double-axis scrolling mode from the vertical scrolling mode and performs the step S500.

Based on the above, the track input device and the scrolling control method configure the scrolling triggering areas in the sensing area, and switch to the scrolling mode based on whether the displacement quantity of the track signal inputted in the scrolling triggering area is greater than the triggering threshold value so as to provide functions of scrolling vertical axis and/or horizontal axis of the window page. Because the scrolling mode cannot be triggered if the displacement quantity of the track signal is smaller than the triggering threshold value, error touch on the scrolling triggering area resulting in frequent mode switch can be avoided. Furthermore, the track input device may maintain the current scrolling mode within a waiting time period after a scrolling signal is sent, and thus it is more convenient for users to continuously scroll the window page.

Note that the specifications relating to the above embodiments should be construed as exemplary rather than as limitative of the present invention, with many variations and modifications being readily attainable by a person skilled in the art without departing from the spirit or scope thereof as defined by the appended claims and their legal equivalents.

What is claimed is:

1. A scrolling control method for a track input device, comprising:
configuring a scrolling triggering area and a cursor area in a sensing area of the track input device;
receiving a first track signal at the sensing area;
determining whether a displacement quantity of the first track signal is greater than a triggering threshold value when the first track signal is received by the scrolling triggering area of the sensing area; and
entering a scrolling mode and sending a scrolling signal when the displacement quantity of the first track signal is greater than the triggering threshold value.

2. The scrolling control method according to claim 1, wherein the scrolling triggering area comprising a plurality of sub-areas, each sub-area corresponding to a scrolling direction, and the step of determining whether the displacement quantity of the first track signal is greater than the triggering threshold value comprising:
determining whether a first component of the displacement quantity corresponding to the scrolling direction is greater than the triggering threshold value according to the sub-area where the first track signal is received.

3. The scrolling control method according to claim 2, wherein the step of entering the scrolling mode and sending the scrolling signal comprising:
entering the scrolling mode and receiving a second track signal at the cursor area; and
sending the scrolling signal according to a second component of a displacement quantity of the second track signal corresponding to the scrolling direction.

4. The scrolling control method according to claim 2, wherein the step of entering the scrolling mode and sending the scrolling signal comprising:
entering the scrolling mode and subtracting the first component with the triggering threshold value to obtain a third component; and
sending the scrolling signal according to the third component.

5. The scrolling control method according to claim 2, after the step of entering the scrolling mode and sending the scrolling signal, the method further comprising:
during a waiting time period, when receiving a third track signal at the cursor area or the sub-area corresponding to the first track signal, maintaining the scrolling mode and sending the scrolling signal according to the third track signal; and
when the sensing area does not receive any track signals during the waiting time period, switching to a cursor mode from the scrolling mode.

6. A track input device, comprising:
a sensing area for receiving a first track signal, the sensing area comprising a scrolling triggering area and a cursor area; and
a controller for determining whether a displacement quantity of the first track signal is greater than a triggering threshold value when the first track signal is received at the scrolling triggering area of the sensing area, and when the displacement quantity is greater than the triggering threshold value, the track input device entering a scrolling mode and the controller sending a scrolling signal.

7. The track input device according to claim 6, wherein the scrolling triggering area comprising a plurality of sub-areas, each sub-area corresponding to a scrolling direction, and the controller determines whether a first component of the displacement quantity corresponding to the scrolling direction is greater than the triggering threshold value according to the sub-area where the first track signal is received.

8. The track input device according to claim 7, wherein after entering the scrolling mode, the controller receiving a second track signal at the cursor area, and sending the scrolling signal according to a second component of a displacement quantity of the second track signal corresponding to the scrolling direction.

9. The track input device according to claim 7, wherein after entering the scrolling mode, the controller subtracting the first component with the triggering threshold value to obtain a third component, and sending the scrolling signal according to the third component.

10. The track input device according to claim 7, wherein during a waiting time period, when receiving a third track signal at the cursor area or the sub-area corresponding to the first track signal, the track input device maintaining the scrolling mode and sending the scrolling signal according to the third track signal, and when the sensing area does not receive any track signals during the waiting time period, track input device switching to a cursor mode from the scrolling mode.
